(19) United States
(12) Patent Application Publication
(10) Pub. No.: US 2025/0176651 A1
(43) Pub. Date: Jun. 5, 2025

(54) HELMET SUPPORT ASSEMBLY, AND HELMET

(71) Applicant: ON BOARD HELMET, LYON (FR)

(72) Inventor: Eliès HAMZAOUI, LYON (FR)

(21) Appl. No.: 18/841,648

(22) PCT Filed: Feb. 23, 2023
(86) PCT No.: PCT/FR2023/050256

§ 371 Date: Aug. 26, 2024

(30) Foreign Application Priority Data
Feb. 28, 2022 (FR) FR2201723

(51) Int. Cl. A42B 3/04; A42B 3/06

(52) U.S. Cl. CPC A42B 3/0406; A42B 3/06

(57) ABSTRACT

“An assembly includes a helmet (2) for protecting the head of a user, and a helmet support (3) intended to be fastened to a bicycle or a scooter. The support (3) has a base (4) having, on one side, a shape matching an inner portion of the helmet (2) in order to be covered by the helmet (2) in a storage position, the base (4) being connected, on an opposite side, to a body (5) for fastening to the bicycle or the scooter. The support (3) has means (14) for locking the storage position of the helmet (2), which means can be actuated remotely by a smartphone. The base (4) has a through-stem (6) terminated by a handle (6a) intended to pass through a corresponding opening (7), formed in a bottom or top of the helmet (2) when the helmet (2) is in the storage position. The stem (6) and the base (4) are mounted pivotably relative to each other about the axis of the stem (6) so as to switch from a release position, in which the handle (6a) is free to pass through the opening (7), to a blocking position for locking the helmet (2) in the storage position, and the locking means (14) being able to block the rotation of the stem (6) with respect to the base (4) in order to lock the blocking position.”

### TECHNICAL FIELD

The invention relates to the technical field of bicycles and scooters, and relates more specifically to a helmet support assembly, and helmet, intended to be fastened to bicycles or scooters, or more generally to any type of soft transport vehicle requiring a helmet to be worn for it to be driven, for example, dandy horse, or other.

The invention has an advantageous application in the field of so-called shared vehicles, without this being limiting.

### PRIOR ART

Document CN111980500 is known from the prior art, which describes an assembly comprising a helmet for protecting the head of a user, and a helmet support intended to be fastened to a bicycle.

The support comprises, in particular, a base having, on one side, a shape matching an inner portion of the helmet in order to be covered by the helmet in a storage position, and the base being connected, on an opposite side, to a type of basket forming a body for fastening to the bicycle.

Like the present invention, the assembly is intended to equip so-called “shared” bicycles, i.e. for self-service rental, in particular, in an urban area.

Thus, the assembly described in this document makes it possible to make a helmet available, also shared, for users of these bicycles.

In order to ensure the helmet is held in position, and to avoid any theft, this document describes that the support comprises means for locking the storage position of the helmet, which means can be actuated remotely by a smartphone.

More specifically, this document describes that the support comprises two laterally retractable stems to be inserted in matching orifices provided for this purpose in a lower inner portion of the helmet.

The stems are retracted by a rack and pinion system, driven by an electric motor, which motor is controlled from information emitted by the smartphone of the user.

However, this type of assembly is complex, large and expensive, and requires performing heavy structural modifications on the helmet to make it compatible with the support.

Moreover, the autonomy of this assembly can also be improved, in order to be able to guarantee the largest number of uses as possible, before requiring recharging.

Document US2021/0179220 is also known, which describes an assembly comprising a helmet for protecting the head of a user, and a helmet support intended to be fastened to a bicycle or a scooter. In this document, the support comprises a base and means for locking a storage position of the helmet, which means can be actuated remotely by a smartphone. The base comprises a stem intended to pass through a corresponding opening arranged in the helmet when the helmet is in the storage position. This assembly can also be improved.

As regards the helmet, this generally comprises a rigid protective shell, coated internally with a comfort foam. This type of helmet is not adapted in terms of hygiene for the field of shared helmets, nor has a good recyclability.

### DISCLOSURE OF THE INVENTION

One of the aims of the invention is therefore to overcome the disadvantages of the prior art by proposing a helmet support assembly, and helmet, which is of simple, reliable and economic design, while being relatively small.

Another aim of the invention is to propose a helmet support assembly which can be easily adapted to any type of soft transport vehicle, and in several possible configurations.

Another aim of the invention is to provide such an assembly which is energy-autonomous and has a low consumption to guarantee as many uses as possible before recharging.

Another aim of the invention is to provide such an assembly which requires few structural modifications on the helmet in order to make the assembly more economical.

To this end, an assembly has been developed, according to that of the prior art in that it comprises a helmet for protecting the head of a user, and a helmet support intended to be fastened to a part of a bicycle or a scooter. The support comprises a base having, on one side, a shape matching an inner portion of the helmet in order to be covered by the helmet in a storage position, and the base being connected, on an opposite side, to a body for fastening to the bicycle or the scooter. The support also comprises means for locking the storage position of the helmet, which means can be actuated remotely by a smartphone.

According to the invention, the base comprises a stem which is through and terminated by a handle. The handle is intended to pass through a corresponding opening which is arranged in a bottom or top of the helmet when the helmet is in the storage position. The stem and the base are mounted pivotably relative to each other, and about the axis of the stem, so as to switch from a release position in which the handle is free to pass through the opening to a blocking position for locking the helmet in the storage position. Moreover, the locking means are able to block the rotation of the stem with respect to the base for locking the blocking position.

From the above, the design is simple, robust, and small. The bulk of the support is not greater than that of the helmet, and is even housed inside the helmet when the helmet is fastened to the support. In this way, the invention makes it possible to propose a helmet support assembly which can be easily adapted to any type of soft transport vehicle, and in several possible configurations. The invention is adapted to both shared vehicles and to personal-use vehicles.

The locking is manual and simple to use. To lock the helmet, it is sufficient to insert it around the stem and to relatively pivot the stem with respect to the base, for example by a quarter-turn. Only the locking and the unlocking of the blocking position is electronic, such that the assembly consumes little energy.

According to a particular embodiment, the assembly comprises identification means, disposed on or in the proximity of the support, for example directly on the bicycle or the scooter, which correspond to a helmet support identified in a database. The identification means can be read by a camera of a smartphone connected to the database, and the locking means are able to be actuated by a signal emitted by the smartphone after having identified the helmet support.

In this way, the unlocking/locking is simple, and can be authenticated and timestamped in the database.

The locking means are of any suitable types, for example, they are in the form of an electric latch adapted to receive and lock an element, for example a finger, rotatably secured to the stem or the base.

In order to consume less energy, the assembly comprises an electronic board equipped with wireless communication means, for example, of the Bluetooth® type, or by radiofrequency, preferably over a long-range wide-area network, or over a 433 Mhz frequency range, or also uses LoRa frequency modulation. It is thus possible to obtain an inexpensive, low-energy-consuming, small wireless communication. The electronic board is thus able to receive an unlocking/locking signal emitted by the smartphone, and the electronic board is configured to actuate the locking means according to the signal received. The communication means, when they are of the Bluetooth® type are preferably used in “Bluetooth low energy” mode, which uses an “advertising” mode, which sends, in a low frequency, every half-second, to not consume too much energy.

Preferably, the base and the stem are slidingly mounted relative to each other, and against an elastic member tending to return to stem inside the base.

Thus, the helmet is firmly held against the base in the storage position, which makes it possible to avoid the helmet vibrating when the bicycle or the scooter is travelling.

Preferably, the base comprises a ridge guiding the sliding of the stem and intended to penetrate into the opening of the helmet in the storage position, in order to prevent a rotation of the helmet around the stem.

Advantageously, the support comprises means for detecting a locked or unlocked state of the locking means, connected to the electronic board which is configured to send a state signal to a smartphone.

In the same way, the support comprises means for detecting the storage position of the helmet, connected to the electronic board which is configured to send a presence signal to a smartphone.

In this configuration, the detection means are, for example, a Hall effect sensor positioned on the stem and intended to engage with a matching element positioned on the base when the helmet is in the storage position.

The fastening body is adapted to be fastened to any type of bicycle or scooter. It can be made bespoke or form an integral part of a bicycle or scooter range. Preferably, the fastening body is made of two parts which can be locked to each other, and on either side of a fixed part of the bicycle or scooter, such as a portion of a frame or handlebars, for example. Fastening is simple, the part of the bicycle or scooter being clamped between the two parts of the fastening body, like a vise.

### BRIEF DESCRIPTION OF THE DRAWINGS

FIG. 1 is a perspective view of a helmet support assembly, and helmet according to the present invention, fastened to the frame of a scooter.

FIG. 2 illustrates the support comprising a fastening body made of two parts fastened on either side of the frame of the scooter.

FIG. 3 is a perspective view of only the support.

FIG. 4 is a longitudinal, cross-sectional view of a first embodiment of the base.

FIG. 5 is a view similar to that of FIG. 4, the stem being slid and pulled upwards.

FIG. 6 is a view similar to that of FIG. 5, as a perspective view, the stem being in a release position, in which the handle is free to pass through the opening formed in the helmet.

FIG. 7 is a view similar to that of FIG. 6, the handle pivoting by a quarter-turn in a blocking position of the helmet.

FIG. 8 illustrates the helmet as a perspective, top view.

FIG. 9 illustrates the helmet as a perspective, bottom view.

### DETAILED DESCRIPTION OF THE INVENTION

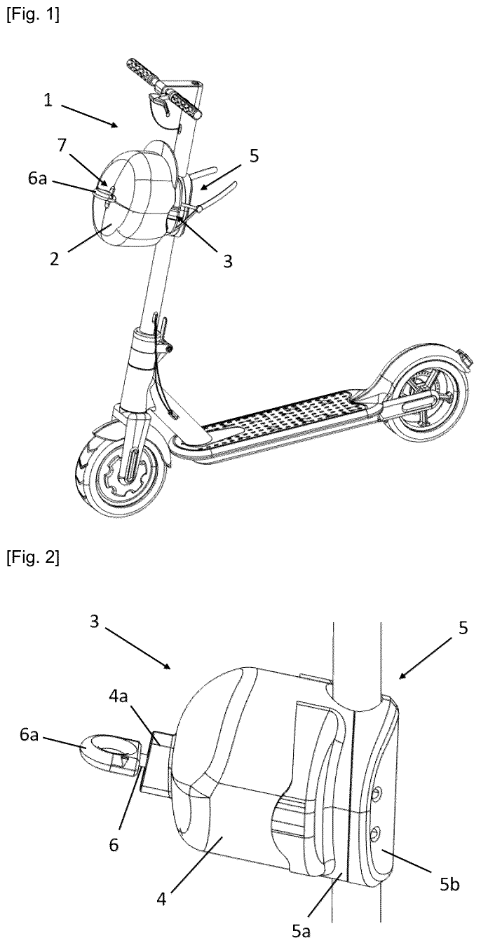

In reference to FIG. 1, the invention relates to an assembly (1) comprising, on the one hand, a helmet (2) for protecting the head of a user travelling on a bicycle or a scooter and, on the other hand, a helmet support (3) intended to be fastened to the bicycle or the scooter.

The invention aims, in particular, to provide a helmet (2), the support (3) of which is intended to equip bicycles or scooters or any other soft transport vehicle, such as a dandy horse, for example. The application can relate to both shared vehicles and personal-use vehicles. The helmet which will be described has been developed to facilitate shared use, but is not limited to this use.

By “shared”, this means the well-known fact that these soft transport vehicles are for collective use, for example in a company fleet, or self-service public use, free-of-charge or for rental. This type of vehicle is more specifically encountered, either as an intra-company travelling means, or in an urban area.

The invention aims to provide such an assembly (1) which is of simple, reliable, small and economical design, while having an autonomous operation and low-consumption, to guarantee the largest number of uses with the available electric charge. The interest of the invention also resides in the fact that the fastening of the support to the vehicle is simple, rapid, and adaptable to any type of vehicle. The proposed solution is called “turnkey”.

In a known manner, and in reference to FIGS. 2 to 7, the support (3) comprises a base (4) having, on one side, a shape matching an inner portion of the helmet (2) so as to be able, in the storage position of the helmet (2), to position it on the support (3) by covering it with the helmet (2).

On an opposite side to the shape for receiving the helmet (2), the base (4) is connected to a body (5) for fastening a part of the bicycle or the scooter, generally the frame, the handlebars, the saddle, the luggage carrier, or any other fixed part of the bicycle or scooter, for example on a fork tube.

The fastening body (5) can be of any suitable type, with it being essential that it ensures a reliable and robust fastening to the bicycle or to the scooter, preferably by avoiding the possibilities of vandalism, or theft.

The fastening body (5) can be made bespoke for a particular bicycle or scooter range, or can directly form an integral part of said bicycle or of said scooter.

According to a particular embodiment, in particular that illustrated in FIGS. 1 and 2, the fastening body (5) is made of two parts (5a, 5b), which can be locked to each other, and on either side of a fixed part of the bicycle or the scooter, in order to sandwich it and ensure the locking.

For example, the two parts (5a, 5b) of the fastening body (5) form two half-shells, leaving a cylindrical space between them to receive a part of a frame or of handlebars and to fasten them around. One of the parts (5a) can form an integral part of the base (2). The locking of the two parts (5a, 5b) to each other is done by any suitable means, for example by screwing, optionally with screws having a head with an indentation intended to engage with a specific tool, not available on the market, to decrease risks of unintentional dismounting.

This embodiment has the advantage of being able to ensure the mounting of the support (3) on a fleet of bicycles or scooters that already exists, without involving any structural modification of the bicycles or scooters.

Naturally, other types of fastening bodies (5) can be imagined, without moving away from the scope of the invention.

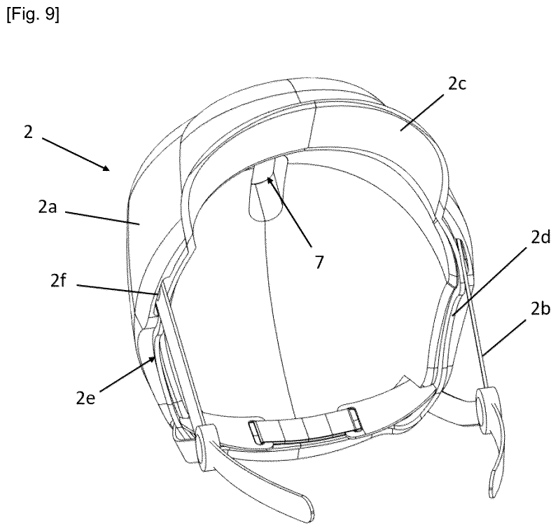

In reference to FIGS. 2 to 7, and in order to ensure the helmet (2) is held in position on its support (3), the base (4) comprises a stem (6) passing through the generally hemispherically-shaped base (4), in particular at the pole or an upper part of the base (4), and is terminated by a handle (6a) in the form of a cove or a buckle intended to pass through a corresponding opening (7), see FIGS. 1 and 8, formed in a bottom of the helmet (2) when the helmet (2) is in the storage position.

In this way, the implementation of the helmet (2) on the base (4) of the support (3) is simple and rapid, it is sufficient, in a manner of speaking, for the helmet (2) to become plugged onto the base (4), with the stem (6) passing through the corresponding opening (7) formed at the top of the helmet (2).

The interest of the invention is that this structure is of simple and reliable design, and requires little, even no structural modification on the helmet (2). In practice, the opening (7) formed at the top of the helmet (2) can act as an airing opening usually present on the helmet (2).

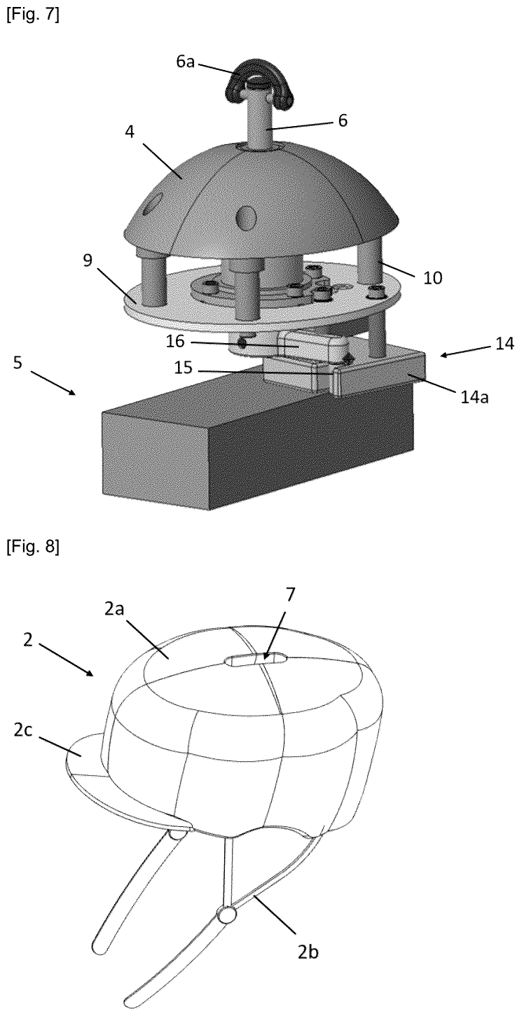

In order to lock the helmet (2) in position, the stem (6) and the base (4) are pivotably mounted, for example by a quarter-turn, relative to each other about the axis of the stem (6). Thus, the pivoting of the stem (6) or of the base (4) makes it possible to switch from a release position, see FIG. 6, in which the handle (6a) is free to pass through the opening (7) to be able to insert or remove the helmet (2), to a blocking position, see FIG. 7, in which the handle (6a) blocks the removal or the insertion of the helmet (2).

According to the embodiment illustrated in FIGS. 4 to 7, the base (4) is fixed, and it is the stem (6) which is mounted pivotably to switch from the release position to the blocking position. Handling for the user is simplified. Conversely, i.e. the stem (6) fixed and the base (4) pivoting can absolutely be considered, without moving away from the scope of the invention.

Preferably, the stem (6) is subjected to a system, not represented, for indexing release and blocking positions, for example, by means of a ball screw connected to the stem (6) or to a part of the base (4), intended to be engaged with matching hollow shapes on the base (4) or the stem (6).

Naturally, the dimensions of the handle (6a) and of the opening (7) arranged in the helmet (2) are adapted to enable locking by rotation. For example, the opening (7) in the helmet (2) is oblong, and the handle (6a) has a general “T”-shape to ensure a locking by rotation, for example by a quarter-turn. Other forms can be considered by a person skilled in the art, without moving away from the scope of the invention.

In order to firmly hold the helmet (2) in the storage position, and to avoid it vibrating when the bicycle or the scooter travels with the helmet (2) on its support (3), the base (4) and the stem (6) are slidingly mounted relative to each other, and against an elastic member (8), in particular a compression spring, tending to return the stem (6) inside the base (4).

In this way, the handle (6a) of the stem (6) forms, in a blocking position, a pressure on the helmet (2) in counter-support with the base (4), such that the vibrations are attenuated, even removed.

According to a preferred embodiment, illustrated in FIGS. 4 to 7, it is the stem (6) which is sliding and the base (4) which is fixed. The other option, namely the stem (6) fixed and the base (4) slidingly mounted around the stem (6) can absolutely be considered, without moving away from the scope of the invention.

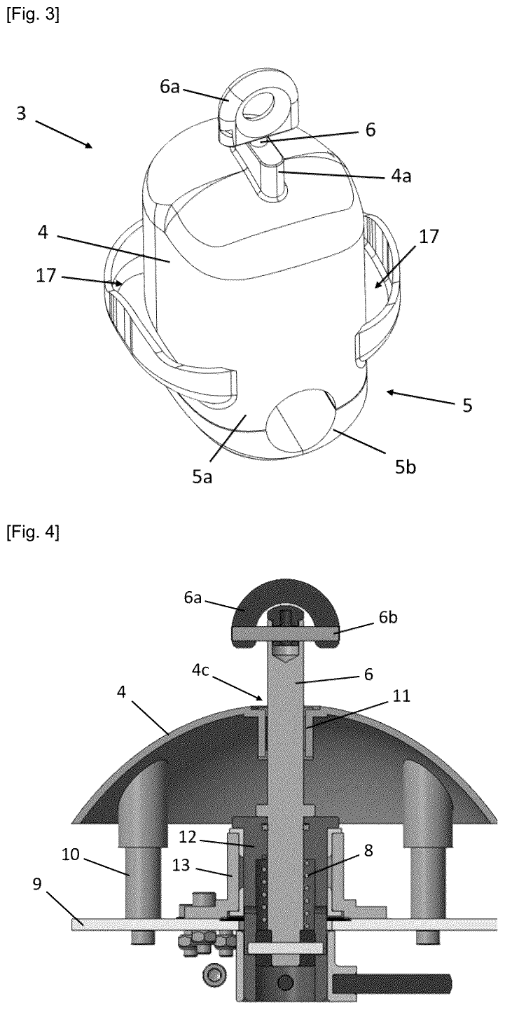

In reference to FIGS. 2 and 3, and in order to prevent any rotary movement of the helmet (2) when it is in the storage position, the base (4) comprises, for example, a ridge (4a) guiding the sliding of the stem (6) and intended to penetrate into the opening (7) of the helmet (2). This ridge (4a) has, for example, a frustoconical, longitudinal cross-section, decreasing by moving away from the base (4), and the opening (7) in the helmet (2) can have a matching cross-section, so as to further decrease the risks of vibration.

Thus, in practice, after having positioned the helmet (2) on its base (4), with the handle (6a) passing through the opening (7) arranged in the helmet (2), the user grips the handle (6a), and pulls to completely release the handle (6a) from the opening (7), and a rotation, for example by a quarter-turn, to switch into a blocking position. Conversely, to remove the helmet (2), the user pulls on the handle (6a), and performs an opposite quarter-turn movement. The operation is simple, reliable and rapid.

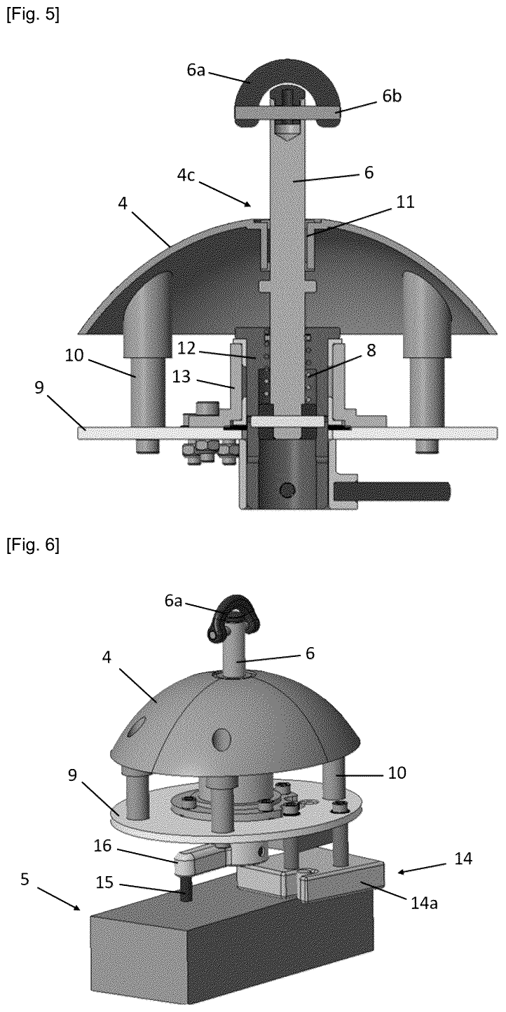

In reference to FIGS. 4 and 5, the handle (6a) is optionally foldable, by being, for example, articulated about an axis (6b) orthogonal to the stem (6) in order to decrease the bulk. It can also be considered that the helmet (2) has an indentation matching that of the handle (6a), in which the handle (6a) is housed in a folded position.

In reference to FIGS. 4 to 7, and to perform the functions which have just been described, the base (4) has a hemispherical shape and is substantially hollow. The base (4) is fastened to a plate (9), for example through peripheral fastening studs (10).

The stem (6) is slidingly mounted by passing through an opening (4c) formed at the top of the base (4), by being guided by sliding seals or rings (11).

In the lower part, the stem (6) is inserted and is guided into a barrel (12), connected to the plate (9). The elastic member (8) tending to return the stem (6) inside the base (4) is positioned between a lower abutment of the stem (6) and an upper abutment of the barrel (12).

The barrel (12) and the stem (6) are rotatably secured, for example through a key, such that a rotation of the stem (6) about its axis also leads to the rotation of the barrel (12). To this end, the barrel (12) is mounted rotatably free about its axis inside a guiding ring (13), secured to the plate (9).

The fact that the barrel (12) is rotatably secured to the stem (6) makes it possible to easily, and reliably and robustly integrate, means (14) for locking the storage position of the helmet (2), in particular by blocking of the rotation of the stem (6) with respect to the base (4), see FIGS. 6 and 7.

According to a particular embodiment, the locking means (14) are, for example, in the form of an electric latch (14a), or a bistable solenoid, adapted to receive and lock an element (15), such as a finger rotatably secured to the stem (6) or the base (4). The operation of the electric latch (14a) consumes little energy.

The electric latch (14a) is, for example, positioned on a fixed part of the support (3), for example fastened to the plate (9) or on a part of the fastening body (5), and the element (15) is, for example, positioned on an arm (16) laterally projecting from the barrel (12). The electric latch (14a) is positioned such that during the rotation of the stem (6), and therefore of that of the barrel (12), the element (15) is inserted and is locked inside the electric latch (14a). The locking is therefore simple and effective.

According to another feature of the invention, the locking/unlocking of the blocking position is done remotely by a smartphone, in particular connected to an app, i.e. a piece of software executed by the smartphone, as this is already known in the field in question of shared bicycles or scooters.

To this end, the support (3) comprises, for example, an electronic board, not represented, equipped with wireless communication means, for example of the Bluetooth® type, or by radiofrequency by using LoRa frequency modulation, so as to be able to receive signals emitted by the smartphone executing the software. And, the electric latch (14a) is able to be actuated by the electronic board according to an unlocking/locking signal emitted by the smartphone executing the software.

Preferably, the support (3) according to the invention comprises identification means, not represented, disposed on or in the proximity of the helmet support (3), for example, directly on the bicycle or the scooter. These identification means are of any known type, and are, for example, of the RFID or 2D code, such as DATAMATRIX code type. These identification means are robust and inexpensive, and implementation is easy.

The identification means disposed on the support (3), the bicycle or the scooter, correspond to a helmet support (3) identified in a database and can be read by a camera of a smartphone connected to the database and executing the software.

In practice, the user scans the identification means with their smartphone which is connected:
to a specific app, i.e. a piece of software executed by the smartphone and programmed to manage making the helmet (2) available;
   or, preferably, directly to the app, i.e. the software, programmed to manage making the bicycle or the scooter available, which thus integrates an API (application programming interface)-type specific module, which is a software interface which makes it possible to “connect” a piece of software or a service to another piece of software or service, in order to exchange data and functionalities, in particular those for managing the helmet (2).

After having read the identification means, and when the matching has been done with respect to the database, which makes it possible to confirm “the identity” of the helmet support (3) in question, the software executed by the smartphone is programmed and configured to propose the unlocking of the blocking position of the helmet (2).

If the user confirms the unlocking through their smartphone, this emits a signal, for example Bluetooth® or by radiofrequency by using LoRa frequency modulation, to the electronic board, which actuates the electric latch (14a) to unlock the rotation of the stem (6).

The electronic board is therefore configured to actuate the locking means (14) according to a signal received by a smartphone.

According to a particular embodiment, the support (3) can comprise a button, not represented, which actuates the wireless communication means of the electronic board, so as to not emit a signal continuously. The user who wants to unlock/lock the helmet, presses on this button and connects their smartphone, such that it detects the signal emitted by the support (3). The signal is emitted by the support (3) for a few seconds, even minutes. This makes it possible to decrease the energy consumption of the support (3).

In order to facilitate managing making the helmet (2) available, the support (3) also comprises means for detecting, not represented, a locked or unlocked state of the electric latch (14a), which means are connected to the electronic board which is also configured to send a signal, for example Bluetooth®, or other, from locked or unlocked state, to the smartphone.

These detection means can be of any suitable types, and are, for example, in the form of a sensor mounted directly on the electric latch (14a).

Still with the same aim, the support (3) comprises means for detecting, not represented, the storage position of the helmet (2), connected to the electronic board which is configured to send a presence signal to the smartphone.

For example, these detection means are in the form of a Hall effect sensor positioned on the stem (6) and intended to engage with a matching element positioned on a part slidingly secured to the base (4). For example, the Hall effect sensor is positioned on the stem (6) and the matching element is positioned in the thickness of the barrel (12). The two elements engage the assembly (1) when the stem (6) is slid with respect to the base (4) by leaving a space between the handle (6a) and the base (4) corresponding to the thickness of the helmet (2).

In this way, the detection is mechanical, simple and inexpensive. When the helmet (2) is in the storage position, the Hall effect sensor is activated and sends information to the electronic board which communicates it to the smartphone.

Then, the user pivots the handle (6a) by a quarter-turn to switch into blocking position, which position is detected and the information is sent to the smartphone. In return, the phone can send a signal to lock the electric latch (14a) such that the user ends, on the software, the use of the helmet (2). In practice, this can, for example, confirm by the software, that a security deposit will not be debited from the account of the user, that the helmet (2) has actually been returned, and that the blocking position has actually been locked.

The invention has been studied to consume little energy and be autonomous, by resorting to the least maintenance as possible. The assembly (1) according to the invention is small and light to not impede or imbalance the operator. The electronic board is powered with a cell positioned in the support (3), and accessible by a flap, for example. The service life, before replacing the cell, is preferably 1 to 2 years, with 3 to 5 uses a day. It can be imagined to power the board by a specific battery, or by the battery of the bicycle or the scooter if they are electric. The battery can be connected to be recharged separately or at the same time as that of the bicycle or the scooter. It can also be imagined that this battery is connected to a solar panel fastened to the support (3) to be recharged autonomously.

In order to avoid or to respond to any attempt of theft or vandalism of the assembly according to the invention, or of the vehicle on which it is installed, the support (3) comprises an anti-theft sensor and/or a GPS tracer, not represented. In particular, the sensor can be a movement detector, associated with a sound alarm, connected to the embedded electronic board. The anti-theft sensor is activated or deactivated, preferably through the app executed on the smartphone, by sending a signal to the electronic board, for example by Bluetooth® or by radiofrequency by using LoRa frequency modulation.

In reference to FIG. 8, the helmet (2) itself also has advantageous features, in line with the field in question of “shared” helmets.

Preferably, the helmet (2) has no shell as such, and resides in a shock absorption layer (2a), which is sealed for a relative protection against rain, and made of one piece. The helmet (2) is therefore made of a layer (2a), for example, made of expanded polypropylene (EPP). The helmet (2) can be recycled and therefore has a satisfactory ecological balance.

The helmet (2) according to the invention is robust and hygienic. To this end, it is, for example, coated with a “smooth” coating such as a varnish, a paint, or a plastic film, in order to give the helmet (2) a certain resistance, while being hygienic and easy to clean.

Preferably, the surface of the EPP one-piece helmet (2) is self-cleaning and/or antibacterial, by adding, into the EPP composition, silver ions, ceramic microspheres, or any other antimicrobial agent. The inner surface of the helmet (2) is continuous, without hollow or raised element, to limit clogging and facilitate cleaning.

Moreover, according to the features taken individually, the helmet (2) comprises straps (2b), made of textile or elastomer material, which is attached on the helmet (2), at the ears of the wearer.

For example, the ends of the straps (2b) have eyelets which are attached around nipples provided for this purpose on the helmet (2), for example inside the helmet (2) so as to leave most of the surface continuous without interference.

In reference to FIG. 3, the base (4) advantageously has slots or side compartments forming housings (17) for receiving said straps (2b), to avoid them floating and bothering the operator when the helmet (2) is not used and is in the storage position, while the bicycle or the scooter is travelling.

According to other advantageous features, independent of the one-piece character of the helmet (2), the helmet (2) internally comprises a tightening ring (2d), well-known from the prior art, provided with a tightening knob or an elastic band to be adapted to the morphology of the wearer.

Preferably, the tightening ring (2d) is extended by a visor (2c) to form a one-piece assembly. The tightening ring (2d) is optionally also extended by the straps (2b) to form a one-piece unit comprising the visor (2c), the tightening ring, and the straps (2b). It can also be considered to not have the visor (2c) and that the one-piece assembly is constituted by the tightening ring (2d) and the straps (2b).

In these different one-piece configurations, the material used is advantageously an elastomer and preferably recyclable material.

Preferably, the visor (2c) can be coated with a textile, like caps.

In reference to FIG. 9, and in order to not impede the continuity of the inner surface of the helmet (2), the tightening ring (2d) is fastened to the edge of the helmet (2). For example, it is housed in a groove (2e) formed along the edge.

The fastening of the clamping ring (2d) can be done by any suitable means, such as by gluing.

The straps (2b) are fastened by any means to the clamping ring (2d) or to the helmet (2) directly. For example, the straps (2b) are fastened by a pin (2f) passing through the end of the straps (2b) and the thickness of the clamping ring (2d). It can also be considered that the pin (2f) also passes through the thickness of the helmet (2) to fasten the assembly.

The straps can also be fastened to loops projecting from the clamping ring. The loops can also project directly from the helmet (2), or be presented in the form of inserts integrated in the helmet (2) at an inner or outer portion.

1. An assembly comprising:
a helmet for protecting the head of a user, and
a helmet support intended to be fastened to a bicycle or a scooter,
the support comprises a base having, on one side, a shape matching an inner portion of the helmet to be covered by the helmet in a storage position, the base being connected, on an opposite side, to a body for fastening to the bicycle or the scooter,
the support comprises means for locking the storage position of the helmet, which means can be actuated remotely by a smartphone,
wherein the base comprises a through stem terminated by a handle intended to pass through a corresponding opening formed in a bottom or top of the helmet when the helmet is in the storage position, the stem and the base are mounted pivotably relative to each other about the axis of the stem so as to switch from a release position, in which the handle is free to pass through the opening, to a blocking position for locking the helmet in the storage position, and in that the locking means are able to block the rotation of the stem with respect to the base for locking the blocking position.

2. The assembly according to claim 1, wherein the assembly comprises identification means disposed on or in the proximity of the helmet support, and corresponding to a helmet support identified in a database, the identification means being readable by a camera of a smartphone connected to the database, the locking means being able to be actuated by a signal emitted by the smartphone after having identified the helmet support.

3. The assembly according to claim 1, wherein the locking means (14) are in the form of an electric latch (14a) adapted to receive an element (15) rotatably secured to the stem (6) or the base (4).

4. The assembly according to claim 1, wherein the support comprises an electronic board equipped with wireless communication means so as to be able to receive an unlocking/locking signal emitted by the smartphone, the electronic board is configured to actuate the locking means according to the signal received.

5. The assembly according to claim 1, wherein the base and the stem are slidingly mounted relative to each other, and against an elastic member tending to return to the stem inside the base.

6. The assembly according to claim 5, wherein the base comprises a ridge guiding the sliding of the stem and intended to penetrate into the opening of the helmet in the storage position, in order to prevent a rotation of the helmet around the stem.

7. The assembly according to claim 4, wherein the support comprises means for detecting a locked or unlocked state of the locking means, connected to the electronic board which is configured to send a state signal to a smartphone.

8. The assembly according to claim 4, wherein the support comprises means for detecting the storage position of the helmet, connected to the electronic board which is configured to send a presence signal to a smartphone.

9. The assembly according to claim 8, wherein the detection means are a Hall effect sensor positioned on the stem and intended to engage with a matching element positioned on the base when the helmet is in the storage position.

10. The assembly according to claim 1, wherein the fastening body is made of two parts which can be locked to each other of a fixed part of the bicycle or the scooter.
